(19) United States
(12) Patent Application Publication
(10) Pub. No.: US 2018/0116011 A1
(43) Pub. Date: Apr. 26, 2018

(54) MOBILE TERMINAL

(71) Applicants: BOE TECHNOLOGY GROUP CO., LTD., Beijing (CN); K-TRONICS (SUZHOU) TECHNOLOGY CO., LTD., Suzhou, Jiangsu (CN)

(72) Inventor: Qi YANG, Beijing (CN)

(21) Appl. No.: 15/552,760

(22) PCT Filed: Feb. 7, 2017
(86) PCT No.: PCT/CN2017/073050

§ 371 Date: Aug. 22, 2017

(30) Foreign Application Priority Data
May 31, 2016 (CN) 201610377592.8

(51) Int. Cl. H04W 88/06; H04B 1/3827; H04B 1/40; H04B 10/116; H04M 1/02

(52) U.S. Cl. CPC H04W 88/06; H04B 1/3833; H04B 1/40; H04B 10/116; H04M 2250/06; H04M 2201/02; H04M 2250/12; H04M 2201/38; H04M 1/0264

(57) ABSTRACT

A mobile terminal includes a body structure, a Lifi transmission control circuit and a Lifi receiving control circuit that are disposed within the body structure, as well as a Lifi transmitting module and a Lifi receiving module that are disposed on the body structure. The Lifi transmission control circuit can be configured to convert first to-be-processed data into a first Lifi signal, and send the first Lifi signal to the Lifi transmitting module. The Lifi transmitting module can be configured to convert the first Lifi signal into a first light-emitting signal and transmit the first light-emitting signal. The Lifi receiving module can be configured to receive a second light-emitting signal, convert the second light-emitting signal into a second Lifi signal, and send the second Lifi signal to the Lifi receiving control circuit. The Lifi receiving control circuit can be configured to convert the second Lifi signal into second to-be-processed data.

### RELATED APPLICATIONS

The present application is the U.S. national phase entry of PCT/CN2017/073050 with an International filing date of Feb. 7, 2017, which claims the benefit of Chinese Patent Application No. 201610377592.8, filed on May 31, 2016, the entire disclosure of which is incorporated herein by reference.

### TECHNICAL FIELD

The present invention relates to the field of communications technology, and more particular to a mobile terminal.

### BACKGROUND ART

Visible light wireless communications technology is also known as light fidelity (Lifi) technology. Lifi technology is a brand-new wireless transmission technology for transmitting data by means of visible spectrum (e.g., light emitted by a light bulb) at a data transmission speed of up to 3 Gbps or above, which is invented by a German physicist, Professor Harald Hass, who is also a chairman of the Mobile Communication Department at the Electronic Communication Institute of Edinburgh University in the UK. Lifi technology is related to the use of a well-laid equipment (like LED lights everywhere), in which a tiny chip is implanted to form an equipment similar to a Wireless Access Point (briefly known as AP), such as a Wifi hotspot, to enable a terminal to have access to network at any time. Lifi technology realizes wireless communication by visible light, i.e., transmitting data by a high-speed flickering signal that are invisible to naked eyes and emitted by a light source under the control of an electric signal. For example, Lifi technology can transmit data by changing the flickering frequency of illuminating lights in a room. The network can be accessed without WiFi as long as an electric light is turned on in the room.

Moreover, in the art, mobile terminals usually communicate with one another directly by way of Bluetooth. But Bluetooth can only achieve one-to-one communication between mobile terminals, one mobile terminal is unable to communicate with a plurality of mobile terminals simultaneously by Bluetooth, and data transmission rate of Bluetooth communication is very limited.

### SUMMARY

To solve or alleviate at least one defect in the art, it is desired to provide a mobile terminal which can realize simultaneous direct communication with a plurality of mobile terminals and meanwhile achieve a higher data transmission rate.

According to one aspect, the present disclosure provides a mobile terminal. The mobile terminal comprises a body structure, a Lifi is transmission control circuit and a Lifi receiving control circuit that are disposed within the body structure, as well as a Lifi transmitting module and a Lifi receiving module that are disposed on the body structure. The Lifi transmission control circuit can be configured to convert first to-be-processed data into a first Lifi signal, and send the first Lifi signal to the Lifi transmitting module. The Lifi transmitting module can be configured to convert the first Lifi signal into a first light-emitting signal and transmit the first light-emitting signal. The Lifi receiving module can be configured to receive a second light-emitting signal, convert the second light-emitting signal into a second Lifi signal, and send the second Lifi signal to the Lifi receiving control circuit. The Lifi receiving control circuit can be configured to convert the second Lifi signal into second to-be-processed data.

In certain exemplary embodiments, the mobile terminal also comprises a main controller module disposed within the body structure. The main controller module can be configured to send the first to-be-processed data to the Lifi transmission control circuit and receive the second to-be-processed data sent by the Lifi receiving control circuit.

In certain exemplary embodiments, the first to-be-processed data comprises network data and/or system data, and the second to-be-processed data comprises network data and/or system data.

In certain exemplary embodiments, the Lifi transmitting module may comprise a light-emitting device and a Lifi chip module. The Lifi chip module can be configured to receive the first Lifi signal which controls the light-emitting device to give out light. The light-emitting device can be configured to generate and transmit the light-emitting signal that passes the first Lifi signal under the control of the Lifi chip module.

In certain exemplary embodiments, the mobile terminal may also comprise a flash lamp disposed on the back side of the body structure, and the light-emitting device can be disposed in the flash lamp.

In certain exemplary embodiments, the Lifi chip module can be disposed in the flash lamp.

In certain exemplary embodiments, the light-emitting device is LED.

In certain exemplary embodiments, the Lifi receiving module is a Lifi sensor.

In certain exemplary embodiments, the mobile terminal may also comprise a display screen disposed on the front side of the body structure, and the Lifi receiving module can be disposed in a non-display region outside the display screen on the front side of the body structure.

In certain exemplary embodiments, the mobile terminal may also comprise a front-facing camera disposed on the front side of the body structure, the front-facing camera may be located within the non-display region, and the Lifi receiving module may be disposed in the front-facing camera. Or alternatively, the mobile terminal may also comprise an optical sensor disposed on the front side of the body structure, the optical sensor may be located within the non-display region, and the Lifi receiving module may be disposed in the optical sensor.

In certain exemplary embodiments, if the mobile terminal comprises a front-facing camera, the front-facing camera may be located above the display screen. Or alternatively, if the mobile terminal comprises an optical sensor, the optical sensor may be located above the display screen.

In certain exemplary embodiments, the Lifi receiving module is located on the front side of the body structure, and the Lifi transmitting module is located on the back side of the body structure; or

the Lifi receiving module is located on the back side of the body structure, and the Lifi transmitting module is located on the front side of the body structure.

The embodiments of the present disclosure can realize at least one advantageous effect among the following advantageous effects and/or other advantageous effects:

In the mobile terminal provided by the present disclosure, there are provided a Lifi transmission control circuit, a Lifi receiving control circuit, a Lifi transmitting module and a Lifi receiving module. The Lifi transmission control circuit and the Lifi transmitting module can realize the function of data transmission with other mobile terminals. The Lifi receiving control circuit and the Lifi receiving module can realize the function of data reception with other mobile terminals. The mobile terminal can achieve direct communication with a plurality of mobile terminals simultaneously by means of the Lifi technology.

### BRIEF DESCRIPTION OF DRAWINGS

To illustrate the technical solutions of the embodiments more clearly, the present disclosure provides the following drawings for describing the embodiments. It shall be appreciated that the following drawings are only related to some embodiments. Without making inventive labor, those ordinarily skilled in the art can also obtain other drawings according to these drawings, and the other drawings are within the scope of the present invention.

FIG. 1 is a front structural schematic view of a mobile terminal according to an embodiment;

FIG. 2 is a back structural schematic view of the mobile terminal in FIG. 1; and

FIG. 3 is a structural schematic view of various functional modules of the mobile terminal in FIG. 1.

Reference signs:

| | |
|---|---|
| 1 Body structure | 2 Display screen |
| 3 Flash lamp | |
| 5 Front-facing camera | 6 Optical sensor |
| 7 Receiver | 8 Back-facing camera |
| 9 Non-display area | |
| 11 Lifi transmission control circuit | 12 Lifi receiving control circuit |
| 13 Lifi transmitting module | 14 Lifi receiving module |
| 15 Main controller module | 16 Mobile communication module |
| 17 Wifi communication module | |

### DETAILED DESCRIPTION

To help those skilled in the art better understand the object, technical solution and advantages of the present invention, a mobile terminal according to some embodiments will be described in detail with reference to the drawings.

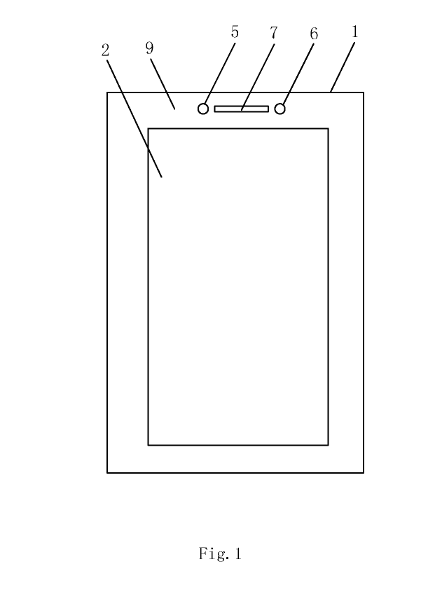

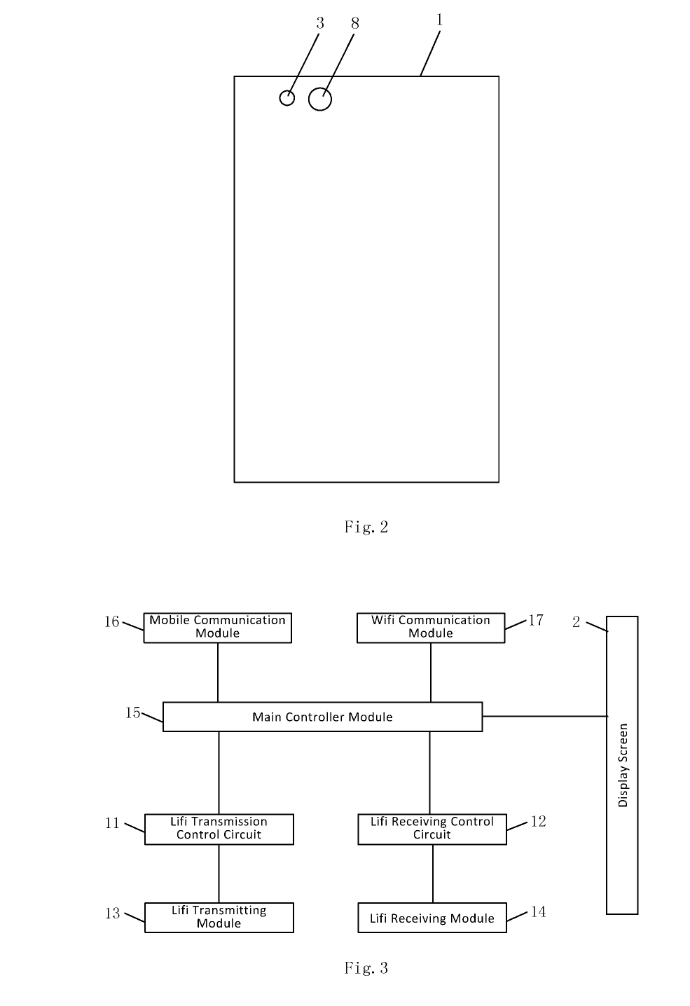

FIG. 1 shows a front structural schematic view of a mobile terminal according to an exemplary embodiment. FIG. 2 shows a back structural schematic view of the mobile terminal in FIG. 1. FIG. 3 shows a structural schematic view of various functional modules of the mobile terminal in FIG. 1. As shown in FIGS. 1 to 3, the mobile terminal may comprise: a body structure 1, a Lifi transmission control circuit 11 and a Lifi receiving control circuit 12 that are disposed within the body structure 1, as well as a Lifi transmitting module 13 and a Lifi receiving module 14 that are disposed on the body structure 1, wherein the Lifi transmission control circuit 11 is connected with the Lifi transmitting module 13, and the Lifi receiving control circuit 12 is connected with the Lifi receiving module 14.

The Lifi transmission control circuit 11 can be configured to convert first to-be-processed data into a first Lifi signal, and send the first Lifi signal to the Lifi transmitting module 13. The Lifi transmitting module 13 can be configured to convert the first Lifi signal into first light-emitting signal and transmit the first light-emitting signal. The Lifi receiving module 4 can be configured to receive a second light-emitting signal, convert the second light-emitting signal into a second Lifi signal, and send the second Lifi signal to the Lifi receiving control circuit 12. The Lifi receiving control circuit 12 can be configured to convert the second Lifi signal into second to-be-processed data.

In an exemplary embodiment, the mobile terminal may also comprise a main controller module 15 disposed within the body structure 1. The main controller module 15 can be respectively connected with the Lifi transmission control circuit 11 and the Lifi receiving control circuit 12. The main controller module 15 can be configured to send the first to-be-processed data to the Lifi transmission control circuit 11 and receive the second to-be-processed data sent by the Lifi receiving control circuit 12.

In an exemplary embodiment, the to-be-processed data comprises network data and/or system data. The mobile terminal may also comprise a mobile communication module 16 disposed within the body structure 1. The mobile communication module 16 is used to receive a network signal from a wireless network, parse the network signal into network data, and send the network data to the main controller module 15. For example, the wireless network may be a 3G or 4G network, the mobile communication module 16 may be a 3G or 4G communication module, wherein the network signal can be parsed into network data by a TCP/IP protocol. The mobile terminal may also comprise a Wifi communication module 17 disposed within the body structure 1. The Wifi communication module 17 is used to receive a network signal from a Wifi network, parse the network signal into network data, and send the network data to the main controller module 15, wherein the network signal can be parsed into network data by an IEEE 802 protocol. The system data may be video, audio, text or photographs stored in a memory (e.g., an SD card or ROM) of the mobile terminal.

In an exemplary embodiment, as shown in FIG. 1, the mobile terminal 1 may also comprise a display screen 2 disposed on the front side of the body structure 1. The main controller module 15 may be connected with the display screen 2. The main controller module 15 can convert the to-be-processed data into display data, and send the display data to the display screen 2 which conducts display according to the display data. Furthermore, the main controller module 15 may also be configured to send a control signal to the Lifi transmission control circuit 11, and the control signal can be used to control the turning-on or turning-off of the Lifi transmission control circuit 11. When the control signal received by the Lifi transmission control circuit 11 is an ON signal, the Lifi transmission control circuit 11 is turned on; and when the control signal received by the Lifi transmission control circuit 11 is an OFF signal, the Lifi transmission control circuit 11 is turned off.

In the above embodiments, the first Lifi signal is a data signal satisfying the Lifi protocol. In an specific example, the first to-be-processed data may be binary data, and the first Lifi signal may be an unipolar code signal. At that time, the Lifi transmission control circuit 11 may convert the first to-be-processed data encoded as binary data into the first Lifi signal encoded as an unipolar code signal so as to encode and module the first to-be-processed data into the first Lifi signal.

In an exemplary embodiment, the Lifi transmitting module 13 may comprise a light-emitting device and a Lifi chip module. The Lifi chip module can be configured to receive the first Lifi signal which controls the light-emitting device to give out light. Under the control of the Lifi chip module, the light-emitting device can be configured to generate and transmit a first light-emitting signal that can pass the first Lifi signal, wherein the first Lifi signal may be an unipolar code signal that may be either a high-level signal represented by “1” or a low-level signal represented by “0”. When the first Lifi signal is a high-level signal, the Lifi chip module can control the light-emitting device to be turned on. When the Lifi signal is a low-level signal, the Lifi chip module can control the light-emitting device to be turned off. The light-emitting device flickers by being turned on and off, thereby generating the first light-emitting signal and transmitting the first light-emitting signal.

As shown in FIG. 2, the mobile terminal may also comprise a flash lamp 3 disposed on the back side of the body structure 1. The light-emitting device can be disposed in the flash lamp 3. In certain exemplary embodiments, the Lifi chip module can also be disposed in the flash lamp 3. In the present embodiment, the Lifi transmitting module 13 and the flash lamp 3 share the light-emitting device, which thereby simplifies the structure of the mobile terminal and reduces the production cost. The Lifi transmitting module 13 is disposed in the flash lamp 3 so as to minimally affect the structure and appearance of the mobile terminal. In certain exemplary embodiments, the light-emitting device is an LED. Furthermore, a back-facing camera 8 can be arranged on the back side of the body structure 1. The flash lamp 3 is disposed to match with the back-facing camera 8 that may be disposed on one side of the flash lamp 3.

The second Lifi signal is a data signal satisfying the Lifi protocol. In a specific example, the second to-be-processed data may be binary data, and the second Lifi signal may be an unipolar code signal. The Lifi receiving module 14 may convert the second Lifi signal encoded as the unipolar code signal into the second to-be-processed data encoded as the binary data so as to decode and module the second Lifi signal into the second to-be-processed data.

In an exemplary embodiment, the Lifi receiving module 14 is a Lifi sensor.

As shown in FIG. 1, a non-display region 9 can be arranged outside the display screen 2 on the front side of the body structure 1. As shown in FIG. 1, for example, the non-display region 9 can be arranged to surround the display screen 2. The Lifi receiving module 14 can be disposed in the non-display region 9 outside the display screen 2 on the front side of the body structure 1.

As shown in FIG. 1, the mobile terminal may also comprise a front-facing camera 5 disposed on the front side of the body structure 1. The front-facing camera 5 may be located within the non-display region 9. The Lifi receiving module 14 may be disposed in the front-facing camera 5. In certain exemplary embodiments, the front-facing camera 5 may be located above the display screen 2 in the non-display region 9. In a specific example, there also may be arranged a receiver 7 on the front side of the body structure 1. The receiver 7 may be located above the display screen 2 in the non-display region 9. The front-facing camera 5 may be disposed at a side, such as a left side, of the receiver 7. The Lifi receiving module 14 can be disposed in the front-facing camera 5, thereby minimally affecting the structure and appearance of the mobile terminal.

As shown in FIG. 1, the mobile terminal may also comprise an optical sensor 6 that may be located within the non-display region 9. The Lifi receiving module 14 may be disposed in the optical sensor 6. In certain exemplary embodiments, the optical sensor 6 may be located above the display screen 2 in the non-display region 9. In a specific example, a receiver 7 may also be disposed on the front side of the body structure 1, and may be disposed above the display screen 2 in the non-display region 9. The optical sensor 6 may be disposed at a side, such as a right side, of the receiver 7. The Lifi receiving module 14 can be disposed in the optical sensor 6, thereby minimally affecting the structure and appearance of the mobile terminal.

In an exemplary embodiment, the Lifi receiving module 14 is located on the front side of the body structure 1, and the Lifi transmitting module 13 is located on the back side of the body structure 1. For example, the Lifi transmitting module 13 is disposed in the flash lamp 3 in FIG. 3, and the flash lamp 3 is disposed on the back side of the body structure 1, so the Lifi transmitting module 13 is located on the back side of the body structure 1. The Lifi receiving module 14 is disposed in the front-facing camera 5 in FIG. 1, and the front-facing camera 5 is disposed on the front side of the body structure 1, so the Lifi receiving module 14 is located on the front side of the body structure 1. By this way, the Lifi receiving module 14 is located on the front side of the body structure 1 and the Lifi transmitting module 13 is located on the back side of the body structure 1, thereby avoiding mutual interference at the time of receiving and transmitting the light-emitting signals. In certain exemplary embodiments, the Lifi receiving module 14 may also be located on the back side of the body structure, and the Lifi transmitting module 13 may also be located on the front side of the body structure, which can also avoid mutual interference at the time of receiving and transmitting light-emitting signals and will not be described in detail. In certain exemplary embodiments, the Lifi receiving module 14 and the Lifi transmitting module 13 can also be both arranged on the front side or back side of the body structure 1, which is not shown. In actual application, the Lifi receiving module 14 and the Lifi transmitting module 13 can also be arranged in other position of the body structure 1, which will not be enumerated.

In an exemplary embodiment, the main controller module 15 can be respectively connected with the Lifi transmission control circuit 11, the Lifi receiving control circuit 12, the mobile communication module 16, the Wifi communication module 17 and the display screen 18 by a system bus. The Lifi transmission control circuit 11 is connected with the Lifi transmitting module 13 by the system bus. The Lifi receiving control circuit 12 is connected with the Lifi receiving module 14 by the system bus. All of the above functional modules of the mobile terminal can transfer data therebetween by the system bus.

In an exemplary embodiment, the mobile terminal can comprise a mobile phone or a pad and any hand-held mobile device in need of network access or inter-device data exchange.

In the above embodiment, the Lifi transmission control circuit 11 and the Lifi transmitting module 13 can realize a Lifi-based data transmission function. The Lifi receiving control circuit 12 and the Lifi receiving module 14 can realize a Lifi-based data receiving function. For example, when the mobile terminal transmits data to another mobile terminal by the Lifi transmission control circuit 11 and the Lifi transmitting module 13, it can simultaneously receive data from a further mobile terminal by the Lifi receiving control circuit 12 and the Lifi receiving module 14, which achieves simultaneous communication with a plurality of mobile terminals.

In the above embodiment, the mobile terminal is provided therein with the Lifi transmission control circuit 11, the Lifi receiving control circuit 12, the Lifi transmitting module 13 and the Lifi receiving module 14. The Lifi transmission control circuit 11 and the Lifi transmitting module 13 can realize the Lifi-based data transmission function with other mobile terminals, and the Lifi receiving control circuit 12 and the Lifi receiving module 14 can realize the Lifi-based data receiving function with other mobile terminals. The mobile terminal can simultaneously communicate with a plurality of mobile terminals by means of the Lifi technology. In addition, the mobile terminal communicates using the Lifi technology, which can improve the transmission rate as compared with Bluetooth and Wifi communication in the art. The mobile terminal can directly communicate with other mobile terminals with no need of additional communication devices. Moreover, the mobile terminal communicates using the Lifi technology, which will not generate electromagnetic interference like Wifi, thereby avoiding interference with such devices as airplane equipment and medical instruments.

It can be understood that the above embodiments are only exemplary embodiments for explaining the principle of the present invention, but the present invention is not limited thereto. Those ordinarily skilled in the art can readily make various variations and modifications without departing from the spirit and substance of the present invention. These variations and modifications will fall within the protection scope of the present invention. The protection scope of the present invention shall be based on the protection scope of the appended claims.

What needs to be explained is that the above embodiments are only illustrated by way of the individual function modules division. In actual application, the above functions can be allocated to different functional modules as desired. The internal structure of the device can be divided into different functional modules so as to accomplish all or part of the functions as stated above. In addition, function(s) of the above one module can be achieved by a plurality of modules, and functions of the plurality of modules can be integrated into one module.

The term “and/or” used herein is only used to describe the connecting relations between objects connected thereby, which may be of three types. For instance, “A and/or B” can represent the following three situations: either A alone, or B alone, or both A and B. In addition, the character “/” used herein generally indicates that the former and the latter objects connected thereby is in a “or” relationship.

The present application uses such wordings as “first” and “second”. Unless specified in the context, such wordings do not imply any order, but are actually used for the purpose of identification. For instance, the phrases “first Lifi signal” and “second Lifi signal” do not necessarily mean the first Lifi signal is positioned in front of the second Lifi signal, or is generated or processed earlier than the second Lifi signal. In fact, these phrases are only used to identify different Lifi signals.

In the claims, any reference sign in parentheses should not be interpreted as a limitation to the claims. The term “comprise/include” does not exclude the presence of elements or steps other than those listed in the claims. The word “a” or “an” in front of elements does not exclude the presence of a plurality of such elements. The mere fact that some measures are recited in mutually different dependent claims does not indicate that the combination of the measures cannot be used to advantage.

1. A mobile terminal, comprising: a body structure, a Lifi transmission control circuit and a Lifi receiving control circuit that are disposed within the body structure, and the mobile terminal further comprising a Lifi transmitting module and a Lifi receiving module that are disposed on the body structure;
the Lifi transmission control circuit can be configured to convert first to-be-processed data into a first Lifi signal, and send the first Lifi signal to the Lifi transmitting module;
the Lifi transmitting module can be configured to convert the first Lifi signal into a first light-emitting signal and transmit the first light-emitting signal;
the Lifi receiving module can be configured to receive a second light-emitting signal, convert the second light-emitting signal into a second Lifi signal, and send the second Lifi signal to the Lifi receiving control circuit; and
the Lifi receiving control circuit can be configured to convert the second Lifi signal into second to-be-processed data.

2. The mobile terminal according to claim 1, wherein the mobile terminal further comprises a main controller module disposed within the body structure,
the main controller module can be configured to send the first to-be-processed data to the Lifi transmission control circuit and receive the second to-be-processed data sent by the Lifi receiving control circuit.

3. The mobile terminal according to claim 1, wherein the first to-be-processed data comprises network data or system data, and the second to-be-processed data comprises network data or system data.

4. The mobile terminal according to claim 1, wherein the Lifi transmitting module comprises a light-emitting device and a Lifi chip module;
the Lifi chip module can be configured to receive the first Lifi signal which controls the light-emitting device to give out light; and
the light-emitting device can be configured to generate and transmit a light-emitting signal that passes the first Lifi signal under the control of the Lifi chip module.

5. The mobile terminal according to claim 4, wherein the mobile terminal also comprises a flash lamp disposed on the back side of the body structure, and the light-emitting device is disposed in the flash lamp.

6. The mobile terminal according to claim 5, wherein the Lifi chip module is disposed in the flash lamp.

7. The mobile terminal according to claim 5, wherein the light-emitting device is LED.

8. The mobile terminal according to claim 1, wherein the Lifi receiving module is a Lifi sensor.

9. The mobile terminal according to claim 1, wherein the mobile terminal further comprises a display screen disposed on the front side of the body structure, and the Lifi receiving module is disposed in a non-display region outside the display screen on the front side of the body structure.

10. The mobile terminal according to claim 9, wherein the mobile terminal further comprises a front-facing camera disposed on the front side of the body structure, the front-facing camera is located within the non-display region, and the Lifi receiving module is disposed in the front-facing camera; or,
the mobile terminal further comprises an optical sensor disposed on the front side of the body structure, the optical sensor is located within the non-display region, and the Lifi receiving module is disposed in the optical sensor.

11. The mobile terminal according to claim 1, wherein the Lifi receiving module is located on the front side of the body structure, and the Lifi transmitting module is located on the back side of the body structure; or
the Lifi receiving module is located on the back side of the body structure, and the Lifi transmitting module is located on the front side of the body structure.

12. The mobile terminal according to claim 2, wherein the first to-be-processed data comprises network data or system data, and the second to-be-processed data comprises network data or system data.

13. The mobile terminal according to claim 6, wherein the light-emitting device is LED.
